(19) United States
(12) Patent Application Publication
(10) Pub. No.: US 2007/0034084 A1
(43) Pub. Date: Feb. 15, 2007

(54) Beverage preparation device

(75) Inventors: Shlomo Shertok, Milwaukee, WI (US); Ofer Batat, Emek Ha'Ella (IL)

Correspondence Address: MICHAEL BEST & FRIEDRICH, LLP, 100 E WISCONSIN AVENUE, MILWAUKEE, WI, 53202, US

(73) Assignee: O & S Development, Inc., Milwaukee, WI (US)

(21) Appl. No.: 11/199,738

(22) Filed: Aug. 9, 2005

(51) Int. Cl. A47J 31/00

(52) U.S. Cl. 99/279

(57) ABSTRACT

A beverage preparation device and a method of dispensing and mixing a beverage. The device includes a fluid tank for holding a fluid, a compartment for holding a powdered beverage, and a powder metering assembly for dispensing a metered amount of powdered beverage into a beverage container. The device also includes a rotatable mixing platform for mixing the fluid and powder within the container and a controller for controlling the amount of fluid dispensed into the container.

### FIELD OF THE INVENTION

The invention relates to beverage dispensers and preparation devices.

### BACKGROUND OF THE INVENTION

Conventional heated beverage dispensers, such as a coffee maker, are known to heat and dispense a beverage for the enjoyment of a consumer. In such beverage dispensers, water is poured into a holding tank. The water is then heated and passed through the coffee grounds into a coffee pot, where the finished coffee is kept warm by a heating plate located under the pot. No further mixing or measuring of the fluid or grounds is done by the beverage dispenser. It is the user that pre-measures the amount of water and coffee grounds to put into the dispenser for one pot of coffee. Thus, the user must empty the used coffee grounds and replace the supply of water in the holding tank and coffee grounds in the basket between pots of coffee.

When making some heated beverages, such as baby formula, it is desirable to provide a beverage preparation device that can hold a supply of powdered formula and a supply of water for reconstituting the formula that allows the user to make multiple servings of baby formula without having to pre-measure the amount of water or powder placed into the dispenser, and without having to replenish the supply of powder and water after each bottle. It is thus desirable to provide a beverage preparation device that keeps the supplies of water and powdered beverage separate until they are mixed in a beverage container, such as a baby bottle.

When making (i.e., reconstituting) baby formula, it is important that the amounts of powdered formula and water that are mixed together are accurately measured for proper reconstitution of an individual bottle. It is thus also desirable to provide a beverage device capable of thoroughly mixing the formula and water together, as well as being capable of dispensing the proper amounts of water and powder for a bottle of a given size. Conventional heated beverage dispensers, such as coffee makers, do not achieve these results.

### SUMMARY OF THE INVENTION

Thus, the present invention provides an improved beverage preparation device for preparing and dispensing a beverage into a beverage container. More specifically, the invention provides a beverage preparation device including a fluid tank for holding a fluid and a compartment for holding a powdered beverage. The beverage preparation device also includes a powder metering assembly for dispensing a metered amount of powdered beverage into the container. A rotatable mixing platform mixes the fluid and powder within the container. The beverage preparation device also includes a controller for controlling the amount of fluid dispensed into the container.

In one embodiment of the invention, the powder metering assembly includes a rotatable divider that is partitioned into sections, each section sized to receive and dispense a predetermined amount of powdered beverage. In another embodiment, the rotatable mixing platform includes a weighing device in communication with the controller for determining the weight of the beverage container and any beverage therein. In another embodiment, the beverage preparation device includes a heating platform in communication with the fluid tank to heat the fluid within the fluid tank to a predetermined temperature. In yet another embodiment, the fluid within the tank is water and the powdered beverage is powdered baby formula such that the beverage preparation device is utilized to prepare reconstituted baby formula.

Other features and advantages of the invention will become apparent to those skilled in the art upon review of the following detailed description, claims, and drawings.

### BRIEF DESCRIPTION OF THE DRAWINGS

FIG. 1 is a perspective view of a beverage preparation device embodying the present invention.

FIG. 2 is a front view of the beverage preparation device of FIG. 1.

FIG. 3 is a front view of the beverage preparation device of FIG. 1, illustrating a beverage container in the device.

FIG. 4 is a perspective view of a mixing platform of the beverage preparation device of FIG. 1.

FIG. 5 is an exploded view of a powdered beverage compartment, including a powder metering assembly, of the beverage preparation device of FIG. 1.

FIG. 6 is a top perspective view of the powder metering assembly of FIG. 5.

FIG. 7 is a bottom perspective view of the powder metering assembly of FIG. 5.

FIG. 8 is a side view of the beverage preparation device of FIG. 1 with the fluid compartment removed.

FIG. 9 is a partial cutaway front view of the beverage preparation device of FIG. 1, illustrating the fluid pump.

FIG. 10 is a schematic drawing, illustrating the control components of the beverage preparation device.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including,” “having,” and “comprising” and variations thereof herein is meant to encompass the items listed thereafter and equivalents thereof as well as additional items.

### DETAILED DESCRIPTION

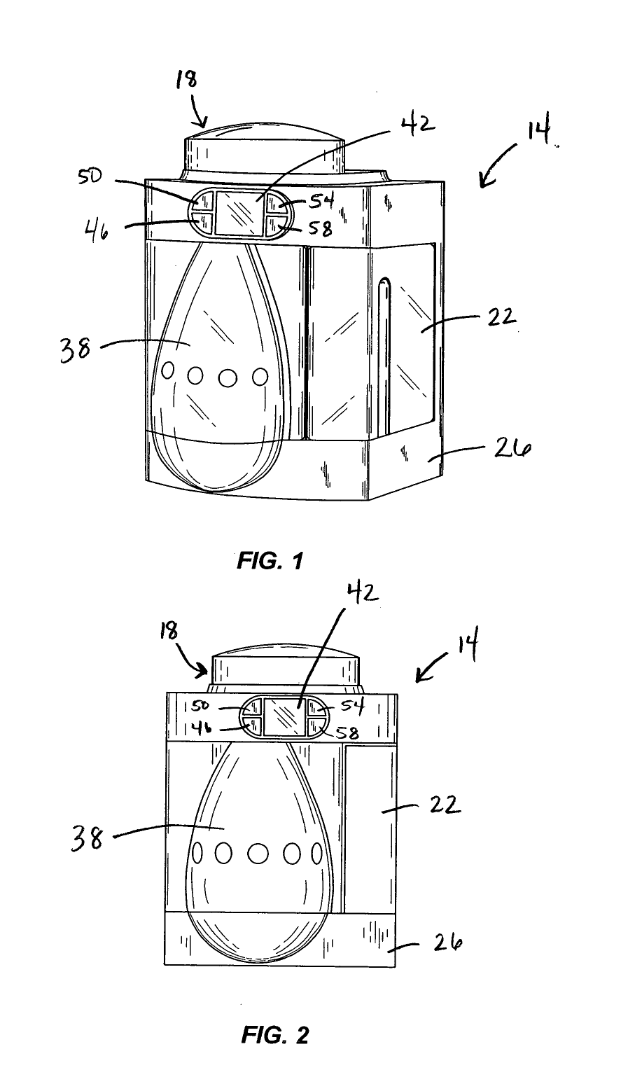

FIGS. 1-3 illustrate a beverage preparation device 14 embodying the invention. The beverage preparation device 14 includes a compartment 18 for holding a powdered beverage, and a fluid tank 22 for holding a fluid to be mixed with the powdered beverage. The compartment 18 and the fluid tank 22 are located within a device housing 26. The beverage preparation device 14 illustrated in the figures and described in detail below is particularly suited for preparing and dispensing reconstituted baby formula to be fed to babies and will be described in the context of preparing baby formula. However, it is understood that the beverage preparation device 14 could be used to prepare and dispense any number of beverages, heated or non-heated, including instant coffee, hot chocolate, hot cider, Kool-Aid®, or any other beverages where an appropriate amount of powdered beverage concentrate is mixed with a fluid, resulting in a desired liquid beverage.

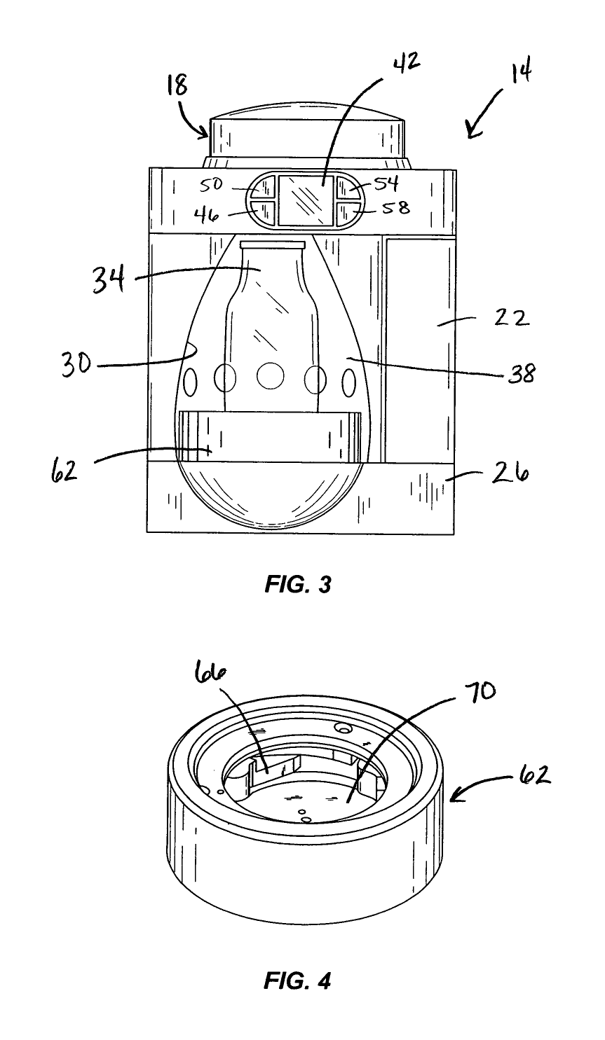

With reference to FIG. 3, the device housing 26 also defines a cavity 30 sized to receive a beverage container 34. In the illustrated embodiment, the beverage container 34 is a baby bottle, but it is understood that any type of beverage container, such as a glass, a mug, or other types of beverage containers, can be used with the beverage preparation device 14 as appropriate. The housing 26 also includes a door 38 that is movable between open (see FIG. 3) and closed (see FIGS. 1 and 2) positions to expose the cavity 30 to allow a user to place a beverage container 34 in the device 14.

In the embodiment illustrated in FIGS. 1-3, the beverage preparation device 14 also includes a programmable, digital clock 42. The clock 42 can be programmed to display the current time for the convenience of the user. The clock 42 can also be used in some embodiments to program automatic bottle preparation at predetermined times. Four buttons 46, 50, 54, 58 are located adjacent to the clock 42 and can be used to set the time or adjust the functions of the device 14. The power button 46 turns the device 14 on when the user wishes to prepare a bottle. The function button 50, in conjunction with the increase and decrease buttons 54, 58, adjusts the function of the device and can be used to set the time on the clock 42. When a user wishes to adjust the amount of formula prepared by the device 14, the user activates the function button 50 and uses the increase or decrease buttons 54, 58 to adjust the amount of formula prepared in one ounce increments. The function button 50 can also be utilized to set a timer for the automatic bottle preparation function discussed above.

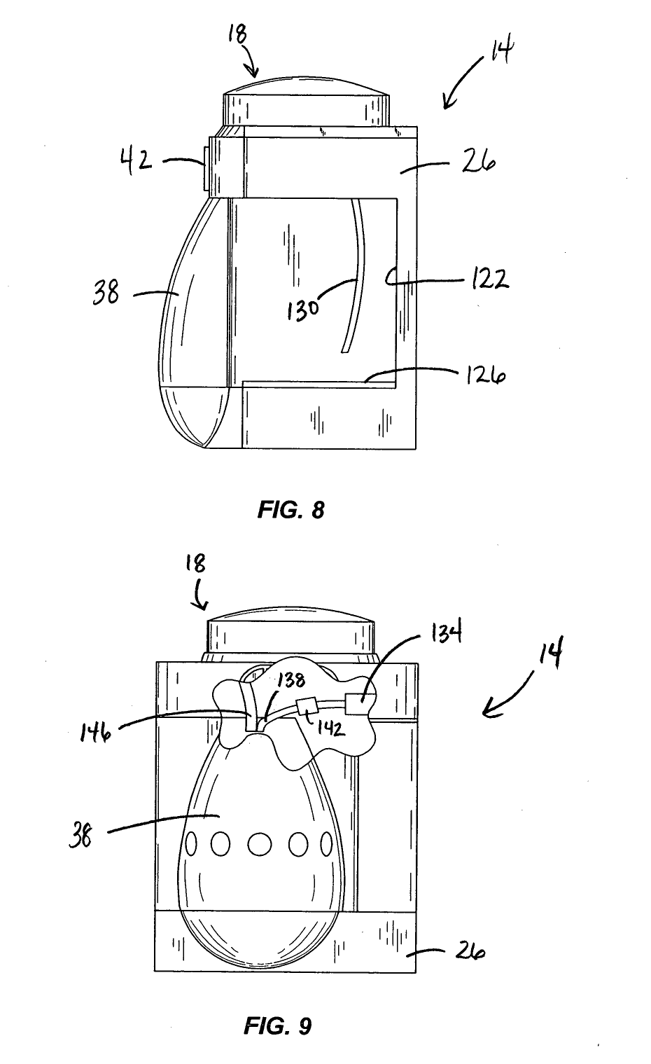

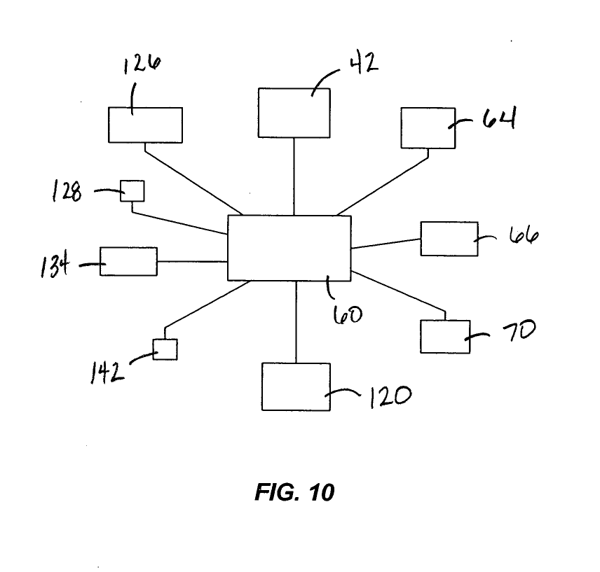

All of the electronic components included in the device 14 are controlled by a central controller 60. The controller 60 includes a memory function such that the device 14 will remember the quantity of formula prepared by the device 14 the last time the device 14 was utilized. The controller 60 is in electrical communication with each of the electrical components in the device 14, as is shown schematically in FIG. 10 and as discussed in more detail with respect to the individual electrical components. The controller 60 is also programmable by the user in that when the user changes the function or quantity desired using the buttons 50, 54, 58, the controller 60 stores the new information and uses that information to adjust the variables in the device, such as how much the prepared bottle should weigh (see the discussion below with respect to FIG. 4), and how long (i.e., how much) water should be added (see the discussion below with respect to FIGS. 8 and 9).

With reference to FIG. 4, the device 14 also includes a mixing platform 62 designed to receive a beverage container 34 therein. The platform 62 includes an adjustable sleeve 66 that is movable such that the platform 62 is capable of receiving beverage containers of various sizes. When a beverage container 34 is placed within the sleeve 66, the sleeve 66 tightens around the container 34 to hold the container 34 snugly within the platform 62. In the illustrated embodiment, the sleeve 66 is automatically adjustable by the controller 60 when the container 34 is placed within the sleeve 66. However, in other embodiments, it is understood that the sleeve 66 may also be manually adjustable.

The platform 62 is rotatable within the housing 26 to facilitate mixing of the powder and fluid when they are placed within the container 34. The platform 62 rotates via operation of a motor 64. The motor 64 is in communication with and is controlled by the controller 60. The motor 64 causes the platform 62 to rotate back and forth to thoroughly mix the powder and fluid in the container to produce a high-quality beverage.

The platform 62 also includes a weighing device in communication with the controller 60, such as a scale 70, for determining the weight of the beverage container 34 and its contents. The scale 70 measures the weight of the contents of the beverage container 34 to maintain the appropriate ratio of powder and fluid in the resulting beverage. The scale 70 communicates the weight of the beverage container 34 to the controller 60, and the controller 60 uses that information to control other functions of the device 14.

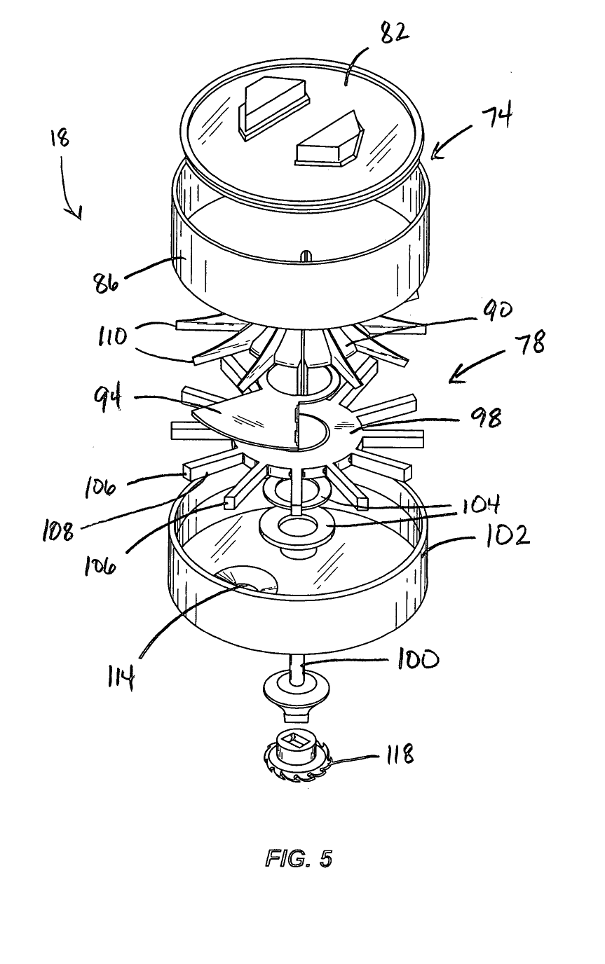

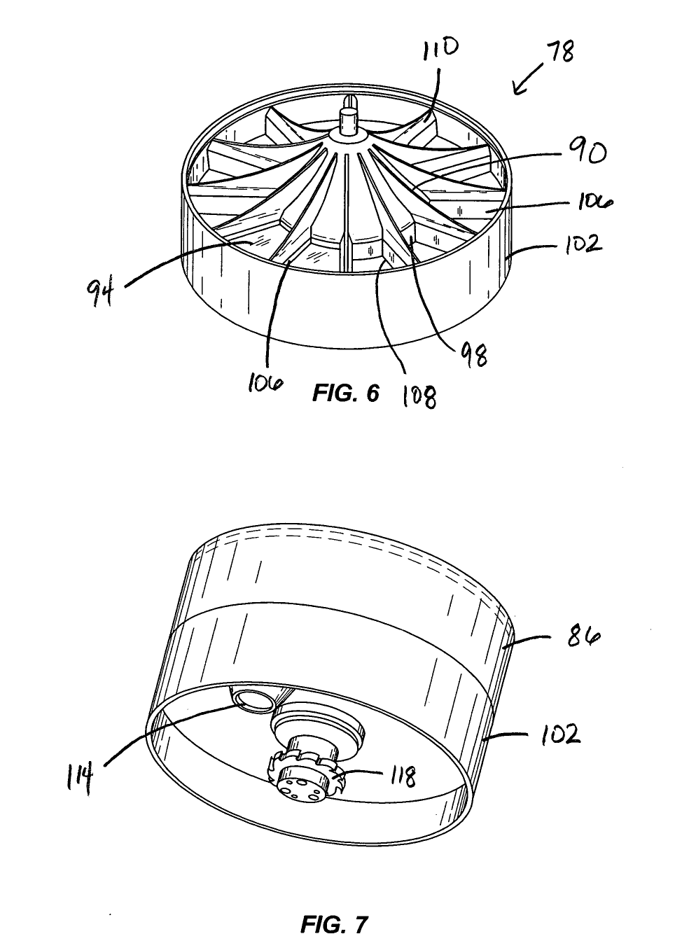

FIGS. 5-7 illustrate the compartment 18 for holding the powdered beverage in detail. The compartment 18 includes a removable cover assembly 74 and a powder metering assembly 78. The cover assembly 74 includes a cover 82 and a sleeve 86. The cover 82 is removable from the compartment 18 to allow a user to refill the compartment 18 with powdered beverage. The sleeve 86 prevents the powdered beverage from falling out of the compartment 18 inside the device 14, which could interfere with the operation of the device 14.

The powder metering assembly 78 includes a separator 90, a divider cover 94, a divider 98, and a powder container 102. One or more washers 104 are coupled between the components of the powder metering assembly 78, particularly between the divider 98 and the container 102. The divider 98 rotates within the powder metering assembly 78 about a shaft 100 to dispense powder into the beverage container 34.

The divider 98 is partitioned into sections 108 by spokes 106. Each pair of spokes 106 defines a section 108 therebetween that can receive an amount of powder required to make one fluid ounce (or thirty ml) of reconstituted formula. The separator 90 also includes spokes 110 that are spaced to mirror the spokes 106 of the divider 98. The spokes 110 of the separator 90 help guide powder into the sections 108 of the divider 98. The divider cover 94 is placed between the divider 98 and the separator 90 and has a width approximately equal to the width of two sections 108 of the divider 98. The function of the divider cover 94 will be explained in more detail below.

With reference to FIG. 7, the container 102 includes an outlet hole 114 that allows the powder to fall out of the compartment 18 into the beverage container 34. The shaft 100 is coupled to a toothed gear 118 that cooperates with a notched gear (not shown) within the housing 26. The toothed gear 118 and notched gear act like a ratchet and pawl, such that the gear 118, and thus the shaft 100, move one tooth or “click” at a time. The gears move under the power of a motor 120. The movement of the motor 120 is controlled by the controller 60. With each click, the divider 98 rotates one section 108 such that the powder within the one section 108 falls through the outlet hole 114.

FIG. 8 illustrates a side view of the device 14, with the fluid tank 22 removed. As illustrated in FIG. 8, the housing 26 also defines a tank cavity 122 within which the fluid tank 22 fits. The fluid tank 22 rests on a heating platform 126. The heating platform 126 includes a heating element that is also controlled by the controller 60 to keep the fluid within the tank 22 at or near a predetermined temperature. The predetermined temperature is preset in the memory of the controller 60, but can vary from device to device, depending on the beverage that you wish to prepare. For example, if the device 14 is intended to prepare and dispense hot chocolate, the predetermined temperature will be higher than if the device 14 is intended to dispense reconstituted baby formula.

The heating platform 126 includes a tank sensor 128, also in communication with the controller 60, to sense the temperature of the fluid within the tank 22. If the fluid in the tank 22 exceeds the predetermined temperature, the tank sensor 128 communicates with the controller 60 to turn off the heating element in the platform 126.

With further reference to FIG. 9, the device 14 includes a fluid tube 130 that is in communication with a fluid pump 134. When the device 14 is activated, fluid is pumped out of the fluid tank 22 by the fluid pump 134 through the tube 130. The fluid is then dispensed into the waiting beverage container 34 through the fluid nozzle 138. As illustrated in FIG. 9, the device 14 includes a temperature sensor 142 coupled to the fluid nozzle 138 that senses the temperature of the fluid being dispensed. The sensor 142 is in electrical communication with the controller 60 such that if a temperature that is higher than the predetermined temperature is sensed, the controller 60 will signal the heating element in the platform 126 to turn off, and will prevent the fluid pump 134 from dispensing any fluid until the temperature falls to the predetermined level. As also illustrated in FIG. 9, the device 14 includes a powder nozzle 146 adjacent to the fluid nozzle 138 that is coupled at one end to the outlet hole 114 in the container 102 to direct the powder from the container 102 to the beverage container 34.

To prepare the device 14 for operation in preparing reconstituted baby formula, the user begins by removing the cover 82 and filling the compartment 18 with powdered formula. The user then removes the fluid tank 22 and fills the tank with water. Any type of water can be used and the water need not be distilled or filtered before being used in the device 14. The user then activates the device 14 by pressing the power button 46. Upon powering, the controller 60 will signal the heating platform 126 to heat the water in the tank 22 to the predetermined temperature. When preparing baby formula, this predetermined temperature is approximately thirty degrees celcius. When the fresh water is added to the tank 22, it can take three or four minutes to heat the water within the tank to the predetermined temperature. Once the water is initially heated to that temperature, the water is maintained at the predetermined temperature.

To prepare a bottle of reconstituted formula, the user opens the door 38 on the front of the device 14 and places a baby bottle (i.e., the beverage container 34) on the platform 62. The user then adjusts the amount of formula desired using the function and increase/decrease buttons 50, 54, 58. The controller memory stores the amount of formula last prepared therein such that the default for the device is to make a bottle containing that same amount. The controller 60 use either the inputted information or the default to control the amounts of powder and water dispensed into the bottle.

The scale 70 then senses the weight of the empty bottle and communicates the weight to the controller 60. The controller 60 then “zeros” the scale. The sleeve 66 tightens around the bottle to hold the bottle within the platform 62. The user then closes the door 38.

The controller 60 activates the motor, rotating the gears 118 and the shaft 100 to rotate the divider 98. As the divider 98 is rotated, the powder in the section 108 adjacent to the divider cover 94 is scraped or leveled by the divider cover 94 such that the section 108 under the divider cover 94 includes a metered amount of powder for one ounce of reconstituted formula. The divider cover 94 also prevents more powdered formula from falling into that section 108 when new powder is added to the compartment 18. The powder falls through the outlet hole 114 and through the powder nozzle 146 into the bottle.

The controller 60 then activates the fluid pump 134 to pump water out of the fluid tank 22 and through the fluid nozzle 138. As the water is dispensed into the bottle, the scale 70 continually weighs the contents of the bottle and transmits the measurements to the controller 60. The controller memory is pre-programmed with the correct weights of powder and water together for bottles of various sizes (e.g., two ounces, four ounces, etc.). Based upon the weight measurements received from the scale, the controller 60 acts as a timer for the fluid pump 134, turning the pump 134 off at the appropriate time such that adequate amount of water is dispensed into the bottle.

The controller 60 then activates the motor 64 to rotate the platform 62 to mix the powder and fluid together. The platform 62 is rotated rapidly back and forth to ensure complete mixing of the powder and water to properly reconstitute the formula. This process is then repeated for each additional ounce of formula that is desired.

The beverage preparation device 14 of the illustrated embodiment is designed to be powered by alternating current (A.C.) power in a user's home or nursery. However, it is understood that in other embodiments, the device 14 can be powered by direct current (D.C.) power, such as in the user's car.

Various features of the invention are set forth in the following claims.

We claim:

1. A beverage preparation device for preparing and dispensing a beverage into a container, the beverage preparation device comprising:
a fluid tank for holding a fluid;
a compartment for holding a powdered beverage;
a powder metering assembly for dispensing a metered amount of powdered beverage into the container;
a rotatable mixing platform for mixing the fluid and powder within the container; and
a controller for controlling the amount of fluid dispensed into the container.

2. The beverage preparation device of claim 1, further comprising a fluid pump in communication with the fluid tank, the fluid pump in electrical communication with and controlled by the controller.

3. The beverage preparation device of claim 1, wherein the powder metering assembly includes a divider, the divider being rotatable within the powder metering assembly.

4. The beverage preparation device of claim 3, wherein the divider is partitioned into sections, and wherein each section is sized to receive a predetermined amount of powdered beverage.

5. The beverage preparation device of claim 4, wherein the predetermined amount of powdered beverage is the amount of powder required to properly reconstitute one fluid ounce of the beverage.

6. The beverage preparation device of claim 4, wherein the powder metering assembly includes an outlet hole, and wherein the divider rotates within the powder metering assembly such that with each rotation, the powder from one section is dispensed through the outlet hole into the beverage container.

7. The beverage preparation device of claim 6, wherein the powder metering assembly includes a divider cover, and wherein the divider cover is sized to cover at least the section over the divider hole such that divider cover will prevent more than the predetermined amount of powdered beverage from being dispensed into the beverage container.

8. The beverage preparation device of claim 3, wherein the divider is coupled to a shaft, and wherein the shaft is rotated within the powder metering assembly via a motor.

9. The beverage preparation device of claim 8, wherein the motor rotates a pair of mating gears, and wherein the rotation of the gears rotates the shaft.

10. The beverage preparation device of claim 1, wherein the rotatable mixing platform includes an adjustable sleeve such that the mixing platform is capable of securing beverage containers of various sizes therein.

11. The beverage preparation device of claim 1, wherein the rotatable mixing platform includes a weighing device in communication with the controller for determining the weight of the beverage container and any beverage therein.

12. The beverage preparation device of claim 1, wherein the fluid within the fluid tank is water, and wherein the powdered beverage is powdered baby formula such that the beverage preparation device is utilized to prepare reconstituted baby formula.

13. The beverage preparation device of claim 1, further comprising a heating platform in communication with the fluid tank, the heating platform controlled by the controller, the heating platform operable to heat the fluid within the tank to a predetermined temperature.

14. The beverage preparation device of claim 13, wherein the device includes at least one temperature sensor in electrical communication with the controller, the temperature sensor operable to sense the temperature of the fluid prior to dispensing of the fluid into the beverage container.

15. The beverage preparation device of claim 1, wherein the controller includes a memory.

16. The beverage preparation device of claim 1, wherein the controller is programmable by a user of the device.

17. A heated beverage preparation device for preparing and dispensing a beverage into a container, the beverage preparation device comprising:
a device housing having a beverage container cavity;
a fluid tank within the housing for holding fluid;
a compartment for holding a powdered beverage;
a heating element for heating the fluid to a predetermined temperature before the fluid is dispensed into the container;
a platform for receiving the beverage container, the platform including a weighing device; and
a controller for controlling the amount of fluid and powdered beverage dispensed into the container.

18. The heated beverage preparation device of claim 17, further comprising a fluid pump in communication with the fluid tank, the fluid pump in electrical communication with and controlled by the controller.

19. The heated beverage preparation device of claim 17, wherein the compartment for holding a powdered beverage includes a powder metering assembly.

20. The heated beverage preparation device of claim 19, wherein the powder metering assembly includes a rotatable divider, and wherein the divider is partitioned into sections, each section sized to receive a predetermined amount of powdered beverage.

21. The heated beverage preparation device of claim 20, wherein the divider is coupled to a pair of mating gears, the gears being rotated by a motor in electrical communication with and controlled by the controller, such that rotation of the gears causes rotation of the divider.

22. The heated beverage preparation device of claim 21, wherein the divider rotates such that with each rotation of the gears, the powder from one section is dispensed into the beverage container.

23. The heated beverage preparation device of claim 17, wherein the platform for receiving the beverage container is rotatable to mix the fluid and powdered beverage within the beverage container.

24. The heated beverage preparation device of claim 17, wherein the weighing device in the platform is a scale, and wherein the scale is in electrical communication with the controller.

25. The heated beverage preparation device of claim 17, wherein the heating element is part of a heating platform, and wherein the heating element is in communication with a tank sensor, the tank sensor operable to sense the temperature of the fluid within the tank and communicate the temperature to the controller.

26. The heated beverage preparation device of claim 17, wherein the controller is programmable by a user of the device.

27. The heated beverage preparation device of claim 17, wherein the fluid is water, and wherein the powdered beverage is powdered baby formula such that the beverage preparation device is utilized to prepare heated, reconstituted baby formula.

28. A method of dispensing and mixing a beverage, the method comprising:
providing a beverage container;
activating a beverage preparation device to dispense a beverage into the beverage container;
metering a desired amount of powdered beverage to be dispensed;
drawing a desired amount of fluid out of a fluid tank, the amount of fluid drawn controlled by a controller;
dispensing the powdered beverage and fluid into the beverage container; and
rotating the beverage container to mix the powdered beverage with the fluid;
wherein the controller is in communication with a weighing device such that the desired amount of fluid is determined by the overall weight of the beverage container.

29. The method of claim 28, wherein metering a desired amount of powdered beverage to be dispensed includes rotating a divider within a powder metering assembly.

30. The method of claim 29, wherein the divider is partitioned into sections, and wherein rotating the divider dispenses the powder from one section into the beverage container.

31. The method of claim 28, wherein drawing the desired amount of fluid out of the fluid tank includes pumping the fluid out of the fluid tank using a fluid pump.

32. The method of claim 28, further comprising heating the fluid within the fluid tank.

33. The method of claim 32, further comprising sensing the temperature of the heated fluid and communicating that temperature to the controller prior to dispensing the fluid into the beverage container.

34. The method of claim 28, further comprising weighing the contents of the beverage container and communicating that weight to the controller.

35. The method of claim 34, wherein the controller maintains the proper ratio of powdered beverage and fluid within the beverage container to produce a properly reconstituted beverage based on the weight communicated to the controller.
